(19) United States
(12) Patent Application Publication
(10) Pub. No.: US 2013/0019527 A1
(43) Pub. Date: Jan. 24, 2013

(54) Mobile, Automatic Plant Growth System

(71) Applicant: Ingrid Howe-Sylvain, Port Saint Lucie, FL (US)

(72) Inventor: Ingrid Howe-Sylvain, Port Saint Lucie, FL (US)

(21) Appl. No.: 13/553,970

(22) Filed: Jul. 20, 2012

Related U.S. Application Data
(60) Provisional application No. 61/572,756, filed on Jul. 21, 2011.

(51) Int. Cl. A01G 31/06; A01G 31/02

(52) U.S. Cl. 47/62 A; 47/62 N

(57) ABSTRACT

A flexible mobile or stationary automated plant growth and display system having a plurality of inter-connected removable or non-removable growing trays. It can be sized as needed and operates in a single or multiple modes using a pump, controller, and mixer that distribute plant nutrients via hydroponic and/or aeroponic water lines to grow chambers using one or more growth methods. It houses a storage area, dual hose bib for external use and a quick access door or lid for the addition of plant nutrients or servicing of pump if submerged. Fluid is recycled from the grow trays through a filter to the plant solution reservoir. The system is equipped with wheels for mobility and anchors for secure and safe operation. It can be mounted on, attached to vehicle or other device, or constructed as part of a vehicle or other device and operated indoors and outdoors.

### FIELD OF INVENTION

The invention relates to aeroponic, hydroponic, soil and aggregate growth methods, container gardening and more specifically to a flexible mobile or stationary self contained automatic plant growth and display system designed to facilitate easier and more convenient plant growth such as vegetables and ornamental plants.

### BACKGROUND OF THE INVENTION

Many people live each day without access to fresh produce; sometimes restricted to only processed food. Some travel miles away from home to a farm such as “U Pick it” to purchase one or two items which they may have to harvest themselves wasting valuable time and money. Others such as retailers of cut plants and vegetables waste valuable plant parts or incur storage or maintenance costs throughout the regular course of business. Many plant growers including home gardeners experience limitations such as with time, physical ability, growing space, plant growth knowledge, and sensitivity to the environment.

Improved technology such as hydroponic and aeroponic systems attempt to address some of these issues but few focus on the small scale grower such as the home gardener. The improvements geared towards home growers are often restricted to gardening in pots, growing a few plants or vegetables at a time and can be labor intensive and wasteful such as a hydroponic system requiring frequent draining. Aeroponic systems generally do not cater to the home gardener or small scale grower. Aeroponic or hydroponic growers produce plants that are generally transported to retailers who must store or maintain plants before they reach the end users often resulting in loss of time, money and nutrients.

Current technology does not allow flexible or multiple growth methods incorporated in one mobile system which would be useful to many including individuals, researchers, and small plant growers. The benefits of aeroponic and hydroponic growth are well known. However, although some plants grow well from cuttings inserted in aeroponic systems, many vegetables are started from seeds which germinate best in soil or other aggregate material. Hydroponic systems geared towards the small grower such as home gardeners are not fully automated, are costly, require frequent draining and have limited growth opportunity allowing growth of one or few plants in each system.

Aeroponic and hydroponic systems although sometimes designed for indoor or outdoor use does not offer mobility and generally cater to commercial growers and when they are designed for the home gardener, they present many limitations. Some examples of prior art are as follows: U.S. Pat. Nos.7,823,328, Pat No. 5,394,647, Pat No. 6,578,319, Pat No. 4,315,381, Pat No. 4,419,842. However, there was not a single system that provided an adequate solution to the problems faced by home gardeners or small scale growers and is most likely the reason that a major home supply retailer discontinued its “Hypergrow 20-⅜ inch hydroponic garden kit” which included 2 terracotta tiered planters and a water pumping system which proved to be limited to the growth of just a few plants and labor intensive.

Current technology does not adequately address these deficiencies. Therefore, a system that eliminates the problems associated with time, waste, growing space, limited plant growth knowledge, insensitivity to the environment, physical limitations and other issues whilst benefiting from the advantages of each growth method is most desirable.

### SUMMARY OF INVENTION

The mobile automatic plant growth system provides an improved system of automatically growing and distributing plants and is a solution to many problems including access to fresh vegetables and for issues associated with home gardening or small scale growing. The invention has many health and economic implications. It is an improvement over current systems by providing access to automatic optional growing methods and the option to grow plants indoors or outdoors. It allows home gardeners or small scale growers the opportunity to automatically grow a variety of plants such as vegetables and ornamental plants conveniently and allows plant purveyors a living plant vendor stand/display that could be used in a retail outlet such as a shopping mall or an outdoor market. Additionally this system can enhance newer and older professions such as vegetable butchering and outdoor market vendor respectively.

The current invention eliminates the limitations of existing systems. It minimizes the time and physical requirements of the small scale grower and allows the plants to grow using the most suitable method. The system can produce enough plants to feed a family and/or the garden can be brought to the end user for consumption eliminating the need to sometimes travel great distances for food that is truly fresh retaining more of its nutrients. It minimizes waste and reduces or eliminates storage, maintenance and transportation costs by those involved in the trade. Parts of living plants can be sold such as cuttings making the plant renewable as new growth occurs. The current invention features options such as solution monitors and nutrient dispenser which if used limit solution errors and reduces environmental contamination.

The pump after receiving instructions from manual/automatic controller distributes plant nutrient solution at required intervals from the water/nutrient reservoir via one or more solution lines/tubings into hydroponic, aeroponic or soil/aggregate grow trays. To begin operation, the reservoir is filled with water, nutrients added, solution mixed and the pump then begins distribution of the nutrients via the hydroponic and/or aeroponic tubing to the grow trays where plant cuttings, seedlings, and the like are located.

The controller together with the pump, solution lines, grow trays, mixer and other components allow operation in a single mode or in multiple modes. The pump may also be used to change liquid. The solution from the grow trays may be filtered and returned to the water/nutrient reservoir or drained externally via the tray drain using the pump or gravity.

The system can be sized as needed is expandable and can be operated in less space making it convenient for use in a commercial or residential location whether it is located indoors or outdoors. It solves the problem of limited physical ability by the home gardener and small scale grower by being less labor intensive. The system minimizes waste by keeping unused portion of plants alive which can spur new growth and reduces or eliminate storage and transportation costs incurred by those in involved in the trade.

The present invention can be operated manually or automatically. The wheeled system with anchors or mounting brackets facilitates mobility so that it can be operated indoors or outdoors or in a stationary position and brings plants directly to consumers securely. The grow trays may be fixedly connected or removable and may be used in multiple applications such as with hydroponic, aeroponic or soil/aggregate growth. The dual hose bib 41 delivers water to the water/nutrient reservoir and provides water for external or other use. The storage area provides a place to store tools, items for retail, and other items as necessary.

### BRIEF DESCRIPTION OF DRAWINGS

FIG. 1 is a plan view showing the exemplary system looking downward.

FIG. 2 is a sectional view showing a cross section of the exemplary system.

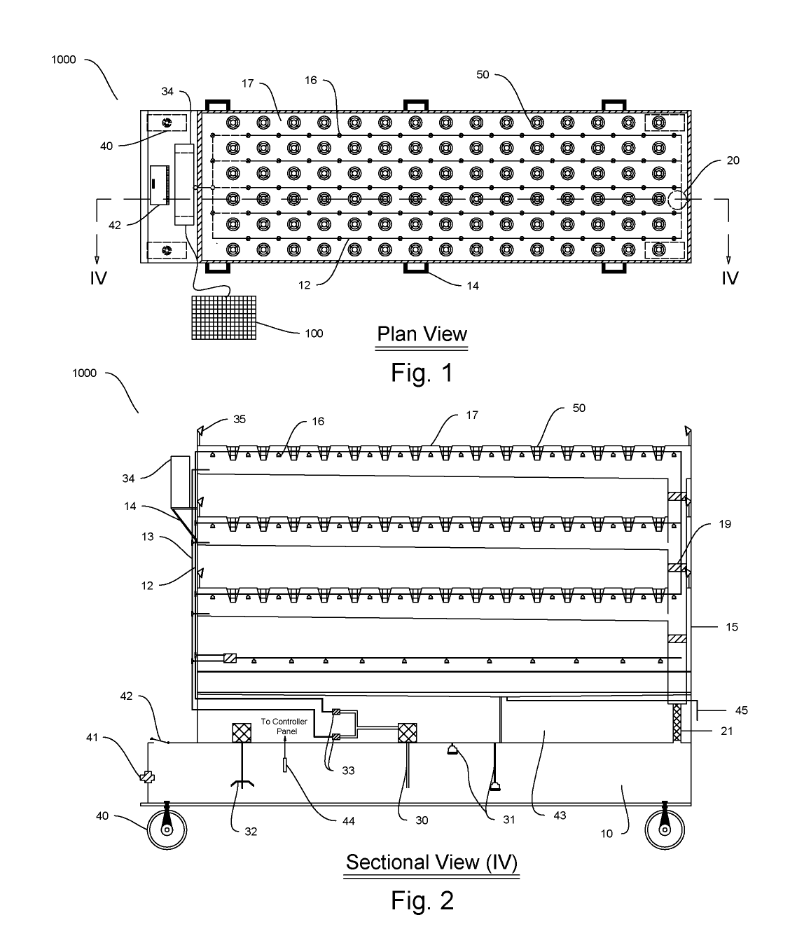

### DETAILED DESCRIPTION OF INVENTION

A detailed description of the exemplary mobile automatic plant growth system 1000 used in a multi-modal mobile capacity is presented. The primary components of the mobile automatic plant growth system 1000 are a frame 15 made of durable material such as steel, a pump 30 that distributes plant nutrient solution from the water/nutrient reservoir 10 via aeroponic solution lines/tubings 12 and/or hydroponic solution lines/tubings 13 into the grow trays 17 using a manual/automatic controller 34. The main components of the mobile automatic plant growth system 1000 are illustrated in FIG. 2 and may be programmed, sized, or fitted with options needed. For example: It can be fitted with solution monitors 44 such as PH and electrical conductivity monitors equipped with probes extending into the solution and connected to the control panel 34 or with an automatic nutrient dispenser similarly connected and programmed to dispense chemical when there's a reading at a certain level. The pump 30 may be more than one and submerged and the tank door/lid 42 or storage area 43 repositioned. It is well known that all plants do not thrive under the same conditions, so the solution distributed the plant must have the correct Ph and nutrient composition. The water/nutrient reservoir 10 may be more than one or partitioned for a different solution so that the tubings from the grow trays 17 are connected to the relevant partition or reservoir so that plants with different growth requirements can be grown together in the system. The return solution from grow tray 17 may be returned to the respective partitions or tanks through drain pipes and multiple filters. However, as previously mentioned the system described is exemplary and is illustrated with one pump 30 and one water/nutrient reservoir 10. The mobile automatic plant growth system 1000 can function in a single mode or multiple modes simultaneously. For example: Hydroponic growth can occur in grow tray 17 made of durable material fixedly connected such as tubular PVC material cemented together without end fittings 16 such as jet sprayers. Hydroponic growth can also occur in a removable tray 17 that may be made of durable or renewable material such as bamboo or customized or made to use existing or new grow containers such as plant baskets or net pots 50. In both cases the tray ends must be sealed or capped 19 to hold the solution.

Aeroponic usage requires pump operation and features tubular or piped end fittings 16 such as those used to deliver nutrients to plant roots for misting and fogging. One application using multiple methods may be use of starter tray 17 with soil/aggregate material to start plants and later transfer them to aeroponic tray 17 after plant roots are gently rinsed. Soil or aggregate tray 17 may also be used to grow plants to maturity.

The pump 30 after receiving instructions from manual/automatic controller 34 distributes plant nutrient solution from the water/nutrient reservoir 10 via one or more solution lines/tubings 12 and/or 13 into the grow tray 17. The pump 30 may also be used to change liquid. The filtered solution may be returned to the water/nutrient reservoir 10 from grow tray 17 via the return filter 21 or unfiltered solution from the grow tray 17 can be drained externally via the tray drain 20 using the pump 30 or gravity. Starter tray 17 used with soil or aggregate material may also be drained externally via tray drain 45.

The mobile automatic plant growth system 1000 is expandable and may be vertically expanded by stacking additional frame 15, adding solution lines/tubings 12 and/or 13, and grow tray 17, and possibly increasing pump 30. The mixer 32 automatically mixes the nutrient added to the water/nutrient reservoir 10 via the tank door/lid 42. High level actuator switch and the off level switches 31 automatically cycles the system on and off as instructed by the controller 34.

The dual hose bib 41 is connected to the water source for the water/nutrient reservoir 10 and for a water hose or pipe for external use such as cleaning up.

The mounting brackets/anchors 14 are fixedly connected to frame 15 such as in a welded or molded construction and are made of durable material such as steel or certain types of PVC material and is constructed to withstand heavy resistance such as during transport?

The wheel base 40 is a weight bearing type such as a type constructed with bearings and filled with air and can easily turn in all directions.

The solar panel 100 or utility power may supply energy. The system is powered on , water fills to programmed level, plant nutrients are added and the system automatically mixes and distributes the plant nutrients cycling on and off as instructed by the control panel 34. Optional grow lights 35 are positioned or used as necessary. When used indoors, the unit could also be placed near a window for sunlight in lieu of grow lights.

Solenoid valves control the solution flow to the various tubings. The solution tank where the solution is automatically mixed is located on the unit and is fitted with materials such as wood to reduce the heat impact of optional grow lights 35 strategically placed. There is no heat impact from the pump which is small.

Finally, the mobile or stationary self contained automatic plant growth and display system 1000 can function without power, although not designed as such but could function as a container garden where plants are grown hydroponically or with soil/aggregate material but has some limitations such as the manual changing of liquids or watering of plants.

1. A mobile automatic plant growth system that is capable of utilizing one or more grow methods and, comprising the following:
a. A water and plant nutrient reservoir from which liquid is pumped;
b. Frame of durable construction for housing and support of components such as grow trays and solution tubings;
c. A pump for pumping or circulating water and/or plant nutrients;
d. Solenoid valves to control the flow of plant nutrient solution or water;
e. High level actuator and off level switches;
f. A reservoir access door;
g. A mixer to mix tank/reservoir components as necessary ;
h. A control panel which controls automatic, single or multimodal operation of the system and is connected to external power of various sources such as solar or utility;
i. Non-removable Grow trays of durable material which are attached to the frame and may be of molded construction and may be used with plant container inserts;
j. Removable grow trays made of durable or renewable material that may be used with plant container inserts;
k. A plurality of water lines and water line apertures inclusive of or excluding varied end fittings for distribution of plant nutrients;
l. Optional closed/capped ends for hydroponic operation;
m. Drain pipe(s) extending from growing trays to the system drain or return filter;
n. A tray drain for external discharge as necessary;
o. A filter between discharge piping from growing trays and water/nutrient reservoir to facilitate recycling;
p. An external storage area;
q. Dual hose bib for filling liquid reservoir and for external application;
r. Wheels to mobilize the system;
s. Mounting brackets or anchors for stabilization or security of unit.
t. Illuminator or grow lights.
u. Optional analytics for monitoring level of organic/inorganic organism in nutrient solution.
v. Optional automatic nutrient dispenser.
w. Connection to any suitable power source and energy efficient components.

2. A mobile automatic plant growth system of claim 1 wherein self-contained system is equipped with wheels and can be operated indoors or outdoors.

3. A mobile automatic plant growth system of claim 1 that allows flexible applications wherein the system can be operated in one or more modes and is equipped with hydroponic and/or aeroponic water lines/tubing.

4. A mobile automatic plant growth system of claim 1 that has attached convenient water valve, hose or nozzle for external applications;

5. A mobile automatic plant growth system of claim 1 wherein the system contains anchors or mounting brackets to stabilize or secure unit;

6. A mobile automatic plant growth system of claim 1 wherein system uses removable grow trays made of renewable material such as bamboo;

7. A mobile automatic plant growth system of claim 1 wherein system is equipped with a storage area.

8. A mobile automatic plant growth system of claim 1 that can be operated manually or as a container garden where plants are grown hydroponically or with soil/aggregate material.

9. A mobile automatic plant growth system of claim 1 wherein optional grow lights are positioned on the unit to aid growth and minimize the costs of illuminating an entire room.

10. A mobile automatic plant growth system of claim 1 wherein the system is used for growth and/or display;

11. A mobile automatic plant growth system of claim 1 wherein the system can be expanded by stacking additional frame, trays, solution pipes/tubing, and possibly increasing the pump size.
